(19) United States
(12) Patent Application Publication
(10) Pub. No.: US 2025/0202680 A1
(43) Pub. Date: Jun. 19, 2025

(54) COMPUTER SERVER, CLIENT-SERVER SYSTEM AND DATA EXCHANGE METHOD IN DOUBLE-BLIND FOR DATA CONFIDENTIALITY AND OPERATIONAL INTEGRITY

(71) Applicant: Commissariat à l’énergie atomique et aux énergies alternatives, Paris (FR)

(72) Inventors: Aymen BOUDGUIGA, Gif-sur-Yvette Cedex (FR); Renaud SIRDEY, Gif-sur-Yvette Cedex (FR); Oana STAN, Gif-sur-Yvette Cedex (FR); Martin ZUBER, Gif-sur-Yvette Cedex (FR)

(73) Assignee: Commissariat à l’énergie atomique et aux énergies alternatives, Paris (FR)

(21) Appl. No.: 18/982,837

(22) Filed: Dec. 16, 2024

(30) Foreign Application Priority Data
Dec. 18, 2023 (FR) 2314410

(51) Int. Cl. H04L 9/00

(52) U.S. Cl. CPC H04L 9/008

(57) ABSTRACT

This computer server comprises:
a database of computer files;
a management module for receiving a request containing a first identifier of a client equipment and a second identifier of a file in the database, the second identifier included in the request having been encrypted via a homomorphic encryption algorithm; then for applying a homomorphic operation to the request to deliver a ciphertext of the file; and
a masking module for receiving the ciphertext of the file; for generating a mask; for delivering a ciphertext of a combination of the file and the mask; and for transmitting the mask to a secure client enclave included in the client equipment, the enclave being able to receive the combination of the file and the mask, then to remove the mask for implementation of the file.

### CROSS-REFERENCE TO RELATED APPLICATIONS

This application is a U.S. non-provisional application claiming the benefit of French Application No. 23 14410, filed on Dec. 18, 2023, which is incorporated herein by reference in its entirety.

### FIELD

The present invention relates to a computer server comprising a database of computer files and a management module configured to receive a request containing a first identifier of a client equipment and a second identifier of one from among the files in the database, the second identifier included in the request having been encrypted via a homomorphic encryption algorithm and an encryption key.

The management module is then configured to apply a homomorphic operation to the request to deliver an encrypted file corresponding to the second identifier, the encrypted file being encrypted according to the homomorphic encryption algorithm and the encryption key.

The invention also has as its object a client-server system comprising client equipment and such a computer server connected to each other.

The invention also has as its object a method for exchanging data between a computer server and a client equipment.

### BACKGROUND

The invention relates to the field of data confidentiality protection.

In particular, the invention relates to the field of homomorphic encryption, otherwise known as homomorphic cryptography. A homomorphic encryption comprises a key pair, an encryption key or public key and a decryption key or private key. Homomorphic encryption allows computations to be executed on data encrypted with the encryption key, and a decrypted result to be obtained via the decryption key.

Such encryption methods are used, for example, by a client equipment wishing to execute a function, the code of which is confidential, included in a computer server, on data that is also confidential. Thus, the computer server has no knowledge of the data provided, and the client equipment cannot recover the function code used.

Nevertheless, homomorphic encryption increases computing time.

Another field of research concerns the use of secure enclaves, also known as Trusted Execution Environments (TEEs).

The article “Toward Scalable Fully Homomorphic Encryption Through Light Trusted Computing Assistance” by W. Wang et al, describes a hybrid method, called Trusted Execution Environment—Fully Homomorphic Encryption, (TEE-FHE) using both fully homomorphic encryption and a secure enclave to improve computational performance. The enclave allows operations to be carried out securely, such as bootstrapping.

However, such a system is not entirely satisfactory.

### SUMMARY

The aim of the invention is therefore to propose a computer server that allows the confidentiality of data exchanges with client equipment to be improved, while maintaining good computing performance.

To this end, the invention has as its object a computer server comprising:
a computer file database;
a management module configured to receive a request containing a first identifier of a client equipment and a second identifier of a file from among the database, the second identifier included in the request having been encrypted via a homomorphic encryption algorithm and an encryption key; the management module then being configured to apply a homomorphic operation to the request to deliver an encrypted file corresponding to the second identifier, the encrypted file being encrypted according to the homomorphic encryption algorithm and the encryption key;
a masking module connected to the output of the management module, the masking module being configured to receive the file encryption, to generate a mask and to deliver an encryption of a combination of the file and the mask;
the masking module being further configured to transmit the mask to a secure client enclave included in the client equipment corresponding to the first identifier, the secure client enclave then being able to receive the combination of the file and the mask, and then to remove the mask for implementation of the file within the secure client enclave.

Encrypting the client request via the homomorphic encryption algorithm allows the client equipment to request the use of a file in the server database without the server being aware of the requested file.

In the present invention, encrypted or homomorphic processing of the request refers to homomorphic processing using the second encrypted identifier.

In addition, execution of the file in the secure client enclave, allows the usually slow file execution in homomorphic encryption to be delegated to the client equipment, which will execute it in clear, in other words, on non-encrypted data, in the secure enclave, thus ensuring the confidentiality of the server function, while offering good computing performance. The management module then processes only the encrypted request, which improves server performance.

Finally, the addition of the mask allows the file to be protected from “curious” client equipment, this mask being removed within the secure enclave, in other words, only inside the secure enclave.

According to other advantageous aspects of the invention, the computer server comprises one or more of the following features, taken alone or in any technically possible combination:
the encrypted request is received from an encryption module included in the client equipment, the encryption module being configured to encrypt the second identifier included in the request via the homomorphic encryption algorithm and the encryption key;
the computer server further comprises a secure server enclave, the secure server enclave comprising an encryption unit, the encryption unit being configured to receive the request from a transmission module included in the client equipment, to encrypt the second identifier included in the request via the homomorphic encryption algorithm and the encryption key, and to provide to the management module the encrypted request;
the masking module is configured to transmit the encrypted file and mask combination to a decryption module included in the client equipment, the decryption module being configured to decrypt the encrypted file and mask combination via a decryption algorithm and a decryption key, and to transmit the decrypted file and mask combination to the secure client enclave;
the computer server further comprises a secure server enclave, the secure server enclave comprising a decryption unit, the decryption unit being configured to decrypt the encrypted file and mask combination via a decryption algorithm and a decryption key and to transmit the decrypted file and mask combination to the secure client enclave;
the or each secure enclave is selected from among the group consisting of an ARM® TrustZone® enclave and an Intel® Software Guard Extensions enclave;
the mask is generated randomly or pseudo-randomly and is for single use only;
the mask being preferably generated via a disposable mask method or via a pseudo-random function;
the homomorphic encryption algorithm is an additive homomorphic encryption algorithm;
the second identifier of the encrypted request is a vector of ciphertexts, the size of the vector being equal to the number of computer files in the database; and
the homomorphic operation applied to the encrypted request is a scalar product.

The invention also relates to a client-server system comprising client equipment and a computer server connected to each other, the computer server being as defined above.

According to a further advantageous aspect of the invention, the client-server system comprises at least one secure channel configured to transmit one information between the client equipment and the computer server.

The invention also relates to a method of exchanging data between a computer server and client equipment, the computer server comprising a computer file database, the method comprising the following steps:
homomorphic encryption of a request via a homomorphic encryption algorithm and an encryption key, the request containing a first identifier of the client equipment and a second identifier of a file from among the files in the database, only the second identifier being encrypted;
application of a homomorphic operation to the encrypted request to deliver an encrypted file corresponding to the second identifier;
generation of a mask and addition of the mask to the ciphertext of the file to form a ciphertext of the file and the mask combination;
decryption of the ciphertext of the file and mask combination via a decryption algorithm and a decryption key;
removal of the mask from the decrypted file and mask combination in a secure client enclave included in the client equipment corresponding to the first identifier;
implementation of the file in the secure client enclave.

### BRIEF DESCRIPTION OF THE DRAWINGS

The invention will become clearer on reading the following description, given only as a non-limiting example, and made with reference to the drawings wherein:

FIG. 1 is a schematic representation of a first embodiment of a client-server system according to the invention;

FIG. 2 is a schematic representation of a second embodiment of the client-server system according to the invention;

FIG. 3 is a schematic representation of a third embodiment of the client-server system according to the invention;

FIG. 4 is a schematic representation of a fourth embodiment of the client-server system according to the invention; and

FIG. 5 is a flowchart of a method for data exchange within the client-server system according to the invention.

### DETAILED DESCRIPTION

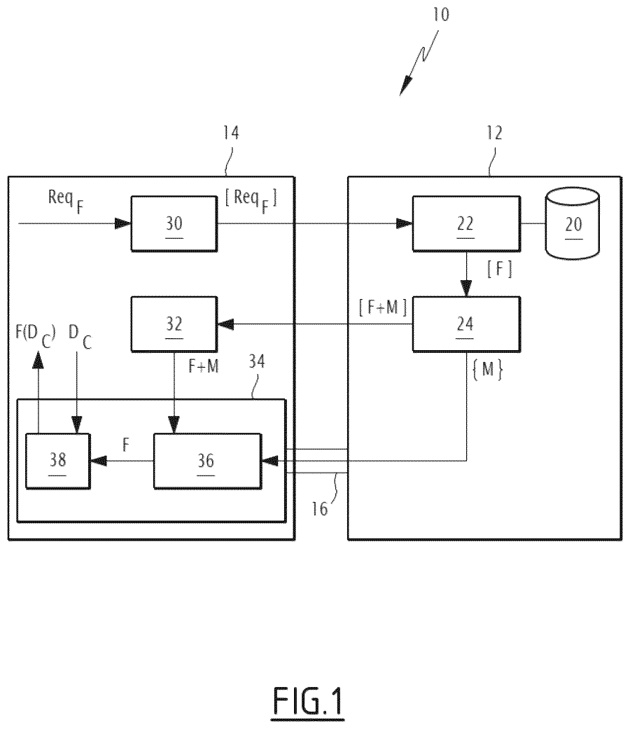

In FIG. 1, a client-server system 10 comprises a computer server 12 and client equipment 14, connected to each other, for example wirelessly, via a radio data link, or by wire.

The client-server system 10 according to the invention has as its object to allow the client equipment 14 to retrieve a file F from the computer server 12 without disclosing the chosen file F, and while assuring the computer server 12 that the client equipment 14 has no access to the file F, for example to the binary of the file F, as will be explained later.

Optionally, the client-server system 10 further comprises a secure channel 16 between the computer server 12 and the client equipment 14. The secure channel 16 is configured to securely transmit information between the client equipment 14 and the computer server 12, in other words, from the client equipment 14 to the computer server 12 or from the computer server 12 to the client equipment 14. The information can then be transmitted in clear, in other words, unencrypted, within the secure channel 16, the information being secured by the secure channel 16 itself. The secure channel 16 is, for example, a Transport Layer Security (TLS) channel.

The computer server 12 comprises a computer file database 20, a management module 22 and a masking module 24. The database 20 is connected to the management 25 module 22.

For example, the database 20 comprises a plurality of computer files stored in clear.

In particular, the database 20 comprises an executable binary of each computer file.

Here and in the rest of the description, “in clear” is taken to mean that the information, such as data or a file, is unencrypted, in other words, the information can be read without the need to perform any decryption operation on said information.

Preferably, the files are arranged according to a vector V_{base} of length N_{base} equal to the number of computer files contained in the database 20, each component of the vector V_{base} corresponding to a computer file.

The computer files are typically programs, software functions, function parameters or software applications. The computer files are, for example, online video game codes, or already trained artificial intelligence algorithms, in particular neural networks, neural network parameters, such as synaptic weights and/or biases. Each computer file is stored in the database 20 as a binary, such as described above, or as a text file, then including, for example, a source code of the function or software application, or even the values of the function parameters.

The computer server 12 consists, for example, of a memory (not represented) and a processor (not represented) associated with the memory.

The management module 22 and the masking module 24 are each realized in the form of one or more software programs, or a software brick, executable by the processor. The memory of the computer server 12 is then able to store management software and masking software. The processor of the computer server 12 is then able to execute the management software and the masking software.

The management module 22 and the masking module 24 are able also to be stored on a computer-readable medium, not represented. The computer-readable medium is, for example, a medium capable of storing electronic instructions and of being coupled to a computer system bus. By way of example, the readable medium is an optical disk, a magneto-optical disk, a ROM memory, a RAM memory, any type of non-volatile memory (for example, EPROM, EEPROM, FLASH, NVRAM), a magnetic card or an optical card. A computer program comprising software instructions is then stored on the readable medium.

The management module 22 is configured to receive a request [Req_{F}] containing a first identifier of the client equipment 14 and a second identifier of a file F from among the files in the database 20, the second identifier included in the request [Req_{F}] having been encrypted via a homomorphic encryption algorithm and an encryption key.

The skilled person will understand that in the encrypted request [Req_{F}], only the second identifier is encrypted, the first identifier being in clear in the said request, whatever the embodiment, in particular, for each of the first, second, third and fourth embodiments described below. The fact that having the first identifier in clear text in said encrypted request [Req_{F}] allows the computer server 12 receiving said request to know the first identifier of the client equipment 14 that transmitted said request to it, so that it can then reply in return.

For example, the homomorphic encryption algorithm is an additive homomorphic encryption algorithm.

For example, the homomorphic encryption algorithm is a Fully Homomorphic Encryption (FHE) algorithm.

To this end, the client equipment14, which initiated the request Req_{F}, knows the position of the desired file F in the database 20. For example, the client equipment 14 knows the position of the file F in the vector V_{base} from among all the files in the database 20.

According to one example embodiment, the second identifier of the encrypted request [Req_{F}] is a vector V_{req} of ciphertext, each ciphertext having been encrypted according to the homomorphic encryption algorithm and the encryption key. The size of the encrypted vector V_{req} is equal to the number N of computer files in the database 20, or to the length of the vector V_{base}. Thus, only the component of the ciphertext vector V_{req} corresponding to the file F is equivalent to a logic 1, in other words, the ciphertext vector V_{req} is configured so that only the file F is selected from among the files in the vector V_{base}.

The management module 22 is then further configured to apply a homomorphic operation to the request [Req_{F}] to deliver a ciphertext [F] of the file F corresponding to the second identifier, the ciphertext [F] of the file F being according to the homomorphic encryption algorithm and the encryption key.

In other words, the management module 22 is then configured to supply as output a ciphertext [F] of the file F, corresponding to the file F having been encrypted via the homomorphic encryption algorithm and the encryption key, the homomorphic encryption algorithm and the encryption key being identical to those used for encrypting the request Req_{F}.

The homomorphic operation allows Private Information Retrieval (PIR) to be performed. In other words, the homomorphic operation allows a file F in the database 20 to be revealed, without indicating to the computer server 12 which file F has been revealed. The skilled person will also note that the file thus obtained is not revealed either, as it is not the file F itself that is obtained, but the ciphertext [F] of the file F.

For example, when the homomorphic operation is of the PIR type, if the encrypted request [Req_{F}] is a ciphertext vector V_{req} as described above and the database 20 comprises a vector V_{base} of computer files in clear, the management module 22 is configured to perform the scalar product of the vector V_{req} and the vector V_{base}. The result of the scalar product then corresponds to the ciphertext [F] of the file F required by the second identifier according to the following equation:

$$[ F ] = {V}_{r e q} * {V}_{b a s e} \qquad [ 1 ]$$

The masking module 24 is configured to receive the ciphertext [F] of the file F supplied as output by the management module 22.

The masking module 24 is then configured to generate a mask M; then to deliver as output a ciphertext [F+M] of a combination of the file F and the mask M. In other words, the masking module 24 is configured to add the mask M to the ciphertext [F].

The mask M is generated randomly or pseudo-randomly.

The mask M is the same length as the ciphertext [F]. For example, if the ciphertext [F] is coded in a number of bits N_{bit}, the mask M comprises N_{bit} values, each value of the mask M being used to mask a value of the file F.

Preferably, the mask M is single use, in other words, a new mask M is generated for each request Req_{F}.

The mask M typically corresponds to an additional encryption that cannot be deciphered by the client equipment 14 if it does not know the key.

For example, the mask M is created by the one-time pad method. In the case of a ciphertext [F] encoded in bits, the mask M is a sequence of bits of the same length as the ciphertext [F]. The F+M combination of the file F and the mask M corresponds, according to this example, to the result of the operation XOR between each bit of the file F and the mask M.

Alternatively, the mask M is formed of N_{bit} random or pseudo-random values, and the F+M combination then corresponds to the result of the addition between each value of the file F and the mask M. For example, the values of the mask M are obtained via a Pseudo Random Function, or PRF.

The masking module 24 is therefore configured to perform the addition of the mask M to the ciphertext [F] of the file F; then to supply as output a ciphertext [F+M] of the file F and the mask M combination, the ciphertext [F+M] corresponding to the F+M combination of the file F and the mask M, encrypted via the encryption algorithm and the encryption key. The encryption algorithm and the encryption key are identical to those used for encrypting the second identifier included in the request Req_{F}.

The client equipment 14 is, for example, formed of a memory (not represented) and a processor (not represented) associated with the memory.

According to a first embodiment, illustrated in FIG. 1, the client equipment 14 comprises an encryption module 30, a decryption module 32 and a secure client enclave 34.

The encryption module 30 and the decryption module 32 are realized in the form of one or more software programs, or a software brick, executable by the processor. The memory of the client equipment 14 is then able to store encryption software and decryption software. The processor of the client equipment 14 is then able to execute the encryption and decryption software.

The encryption module 30 and the decryption module 32 are also able to be stored on a computer-readable medium, not represented. The computer-readable medium is, for example, a medium capable of storing electronic instructions and of being coupled to a computer system bus. By way of example, the readable medium is an optical disk, a magneto-optical disk, a ROM memory, a RAM memory, any type of non-volatile memory (for example, EPROM, EEPROM, FLASH, NVRAM), a magnetic card or an optical card. A computer program containing software instructions is then stored on the readable medium.

The encryption module 30 is configured to encrypt the second identifier included in the request Req_{F} via the homomorphic encryption algorithm and the encryption key.

The decryption of the encryption algorithm can only be executed via a decryption algorithm and a decryption key, also known as a private key, known only to the client equipment 14.

Preferably, the encryption is asymmetrical, in other words, the decryption key differs from the encryption key.

The encryption module 30 is then configured to take the request Req_{F} in clear as input; then to supply as output the ciphertext [Req_{F}] to the management module 22.

Thus, the computer server 12 only receives the ciphertext request [Req_{F}] and cannot determine the request Req_{F} in clear, as it does not know the decryption key. In other words, the computer server 12 cannot determine the file F required by the client equipment 14. The encryption of the request Req_{F} ensures confidentiality for the client equipment14 of the second identifier included in its request Req_{F}, and in particular the identity of the required file F.

The decryption module 32 is configured to receive the ciphertext [F+M] of the file F and the mask M combination, supplied by the masking module 24. The masking module 24 identifies the client equipment 14 to which the ciphertext [F+M] combination is to be transmitted via the first identifier of the request [Req_{F}].

The decryption module 32 is further configured to decrypt the ciphertexts [F+M] of the file F and the mask M combination via the decryption algorithm and the decryption key; then to transmit the decrypted F+M combination of the file F and the mask M to the secure client enclave 34.

The decryption algorithm is configured to decrypt an element encrypted via the homomorphic encryption algorithm and the encryption key, this thanks to the decryption key.

The output of the decryption module 32 corresponds to the decrypted F+M combination of the file F and the mask M, so the client equipment14 does not have access to the file F alone in clear. Thus, the mask M allows the computer server 12 to protect the confidentiality of the file F from said “curious” client equipment.

The secure client enclave 34 comprises an unmasking unit 36 and an implementation unit 38 of the file F.

The secure client enclave 34 is a Trusted Execution Environment (TEE). The secure client enclave 34 is chosen, for example, from among the group consisting of: an ARM® TrustZone® enclave and an Intel® Software Guard Extensions enclave, also known as Intel® SGX.

The secure client enclave 34 is hosted by the client equipment 14; and the computer server 12 communicates with the secure client enclave 34. However, neither the computer server 12 nor the client equipment 14 has access to the contents of the secure client enclave 34.

The unmasking unit 36 is able to receive the F+M combination of the file F and the mask M; then to remove the mask M for implementation of the file F within the secure client enclave 34.

To this end, the masking module 24 is further configured to transmit the mask M to the unmasking unit 36 which is included in the secure client enclave 34 of the client equipment 14 corresponding to the first identifier of the request Req_{F}.

The unmasking unit 36 is able to supply as output the file F in clear to the implementation unit 38.

In other words, having previously received the mask M, the unmasking unit 36 is configured to perform the following calculation:

$$( F + M ) - M = F \qquad [ 2 ]$$

The implementation unit 38 is configured to execute the file F in clear text, which allows good execution performance and avoids data exchanges between the computer server 12 and the client equipment 14.

For example, the implementation unit 38 is configured to receive a set of data D_{C} from the client equipment 14; then to execute the file F on the data D_{C}; and finally, to transmit the result F(D_{C}) to the client equipment 14 outside the secure client enclave 34.

Thus, the computer server 12 does not receive the potentially confidential data D_{C}, and the client equipment 14 does not have access to the function F in clear, but only to the result F(D_{C}) from the secure client enclave 34.

For example, the file F is an artificial intelligence algorithm, such as a neural network, supplying from a set of input data, an output comprising information determined from the input data. The client-server system 10 then allows the client equipment 14 to use the artificial intelligence algorithm in order to obtain information from its data D_{C}, without the computer server 12 having access to the data D_{C}. In addition, the computer server 12 shares this algorithm from its database 20, without itself risking that the client equipment 14 has access to the algorithm parameters.

As an optional addition, in order to reinforce confidentiality for the client equipment 14 and to ensure the computer server 12 that the file F is indeed executed in the secure client enclave 34, the client-server system 10 uses attestation protocols, or Remote Attestation (RA).

As a further optional addition, the client-server system 10 comprises mechanisms for validation of the integrity of the file F executed by the implementation unit 38. For example, the file F is signed by a third-party authority, separate from the client equipment 14 and the computer server 12, to ensure its integrity and to ensure the client equipment 14 that the file F does not contain a flaw that would allow data leakage toward the computer server 12. Alternatively, the file F is signed by the computer server 12 itself, in order to ensure the client equipment 14, in particular the secure client enclave 34, that the file F received emanates from the computer server 12 and has not been corrupted by a malicious entity, which would have been able to intercept and then corrupt the file F during its transmission from the computer server 12 to the secure client enclave 34.

In the example shown in FIG. 1, the secure channel 16 is configured to transmit the mask M from the masking module 24 of the computer server 12 to the unmasking unit 36, included in the secure client enclave 34 of the client equipment 14.

Alternatively, the client equipment 14 has the possibility to cut off communications between the computer server 12 and the secure client enclave 34.

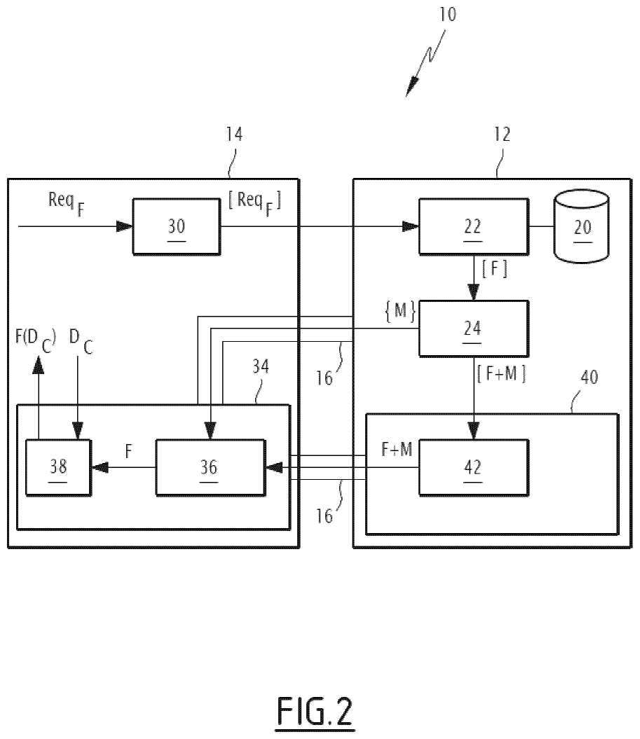

A second embodiment of the client-server system 10 according to the invention will now be described, with reference to FIG. 2. Only the differences between the first embodiment described above and the second embodiment are described below.

In the example of FIG. 2, the computer server 12 also comprises a secure server enclave 40.

The secure server enclave 40 is a Trusted Execution Environment (TEE). The secure server enclave 40 is chosen, for example, from among the group consisting of: an ARM® TrustZone® enclave and an Intel® Software Guard Extensions enclave, also known as Intel® SGX.

The secure server enclave 40 comprises a decryption unit 42.

The decryption unit 42 is configured to receive the encrypted [F+M] combination of the file F and the mask M, supplied by the masking module 24.

The decryption unit 42 is further configured to decrypt the ciphertext [F+M] of the combination of the file F and the mask M via the decryption algorithm and the decryption key. The decryption unit 42 is then configured to transmit the decrypted F+M combination of the file F and the mask M to the secure client enclave 34 corresponding to the first identifier of the request Req_{F}, in particular to the unmasking unit 36, the decryption key having been transmitted previously to the secure server enclave 40.

The secure server enclave 40 allows the encrypted [F+M] combination of the file F and the mask M to be decrypted, without the computer server 12 having access to the file F, which prevents the computer server 12 from being able to determine the second identifier of the request Req_{F} transmitted in encrypted form by the client equipment 14.

Homomorphic decryption in the secure server enclave 40 allows bandwidth to be saved when sending the F+M combination to the secure client enclave 34. Indeed, sending the ciphertext [F+M] combination requires more bandwidth than sending the decrypted F+M combination.

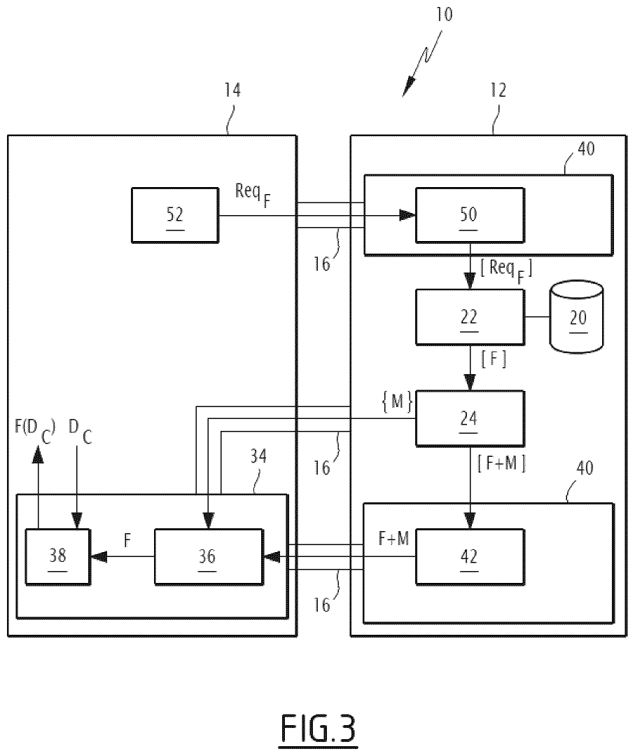

A third embodiment of the client-server system 10 according to the invention will now be described, with reference to FIG. 3. Only the differences between the second embodiment described above and the third embodiment are described below.

In the example of FIG. 3, the secure server enclave 40 also comprises an encryption unit 50.

The encryption unit 50 is configured to receive the request Req_{F} in clear transmitted by a transmission module 52 included in the client equipment 14; then to encrypt the second identifier included in the request Req via the homomorphic encryption algorithm and the encryption key; and finally, to supply the management module 22 with the encrypted request [Req_{F}].

The transmission module 52 is implemented in the form of one or more software programs, or a software brick, executable by the processor. The memory of the client equipment 14 is then able to store transmission software. The processor of the client equipment 14 is then able to execute the transmission software.

Thus, the encryption of the second identifier included in the request Req_{F} is performed by the computer server 12, and no longer by the client equipment 14.

The encryption unit 50 being included in the secure server enclave 40, the computer server 12 has no access to the request Req_{F} in clear.

In addition, the request Req is transmitted from the transmission module 52 included in the client equipment 14 to the encryption unit 50 included in the computer server 12 via the secure channel 16.

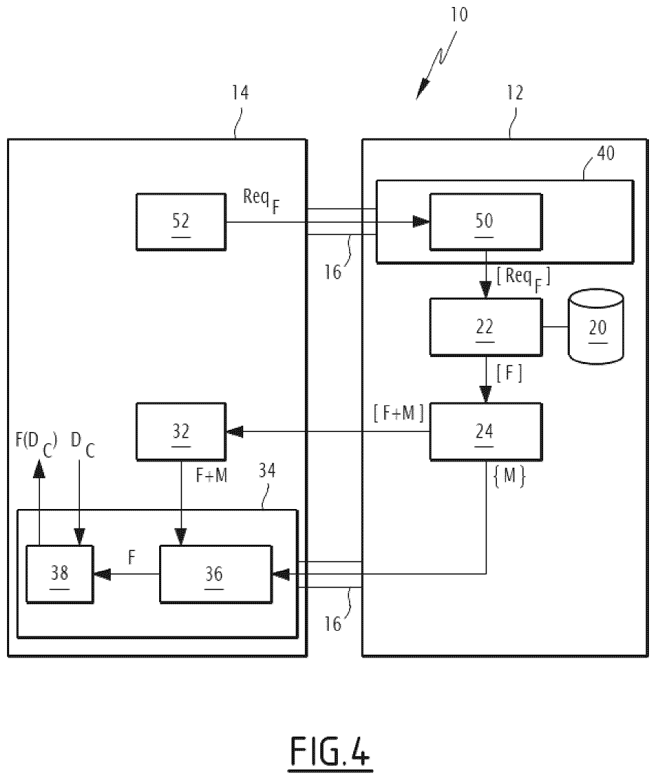

According to a fourth embodiment of the client-server system 10 according to the invention, with reference to FIG. 4, the client-server system 10 is configured so that the homomorphic encryption is performed by the encryption unit 50 included in the secure server enclave 40 and the homomorphic decryption is performed by the decryption module 32 included in the client equipment 14.

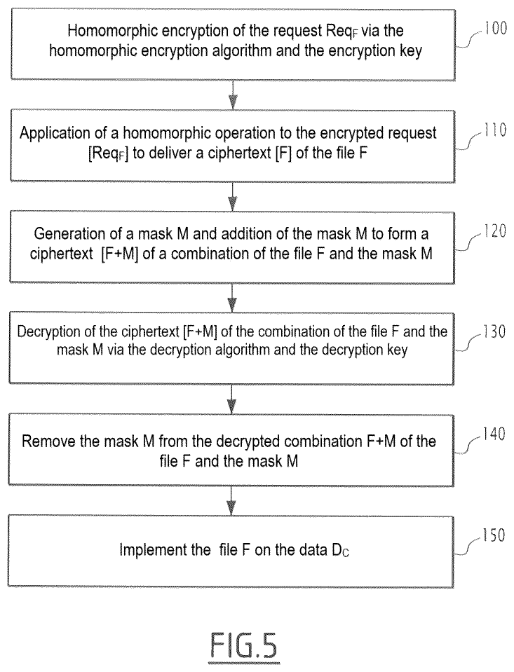

A method of exchanging data between the computer server 12 and the client equipment 14 according to the invention will now be described, with reference to FIG. 5. This method is applicable to all the embodiments described above.

Such a method is implemented, for example, when the client equipment 14 requests the execution of a file F included in the computer server 12.

For example, the client equipment 14 wishes to have access to a file F included in the database 20 of the computer server 12. The client equipment 14 generates the request Req_{F} containing the first identifier of the client equipment 14 and the second identifier of the file F from among the files in the database 20.

The method allows, for example, a user to use artificial intelligence algorithms locally on the client equipment 14, already trained and stored on the computer server 12, without the computer server 12 knowing the algorithm chosen by the client equipment 14 and also without the client equipment 14 having access to the algorithm code, and therefore to its parameters.

According to another example, the method allows a user to run in his Internet browser an online video game chosen from among a set of games stored on a computer server 12, without the computer server 12 having access to the chosen game, thus avoiding, for example, targeted advertising for the client equipment 14, and also without the client equipment 14 having access to the game code.

In a first step 100, the second identifier included in the request Req_{F} is encrypted via the homomorphic encryption algorithm and the encryption key.

According to the first and second embodiments, the homomorphic encryption is performed by the encryption module 30 included in the client equipment 14.

According to the third and fourth embodiments, the homomorphic encryption is performed by the encryption unit 50 included in the secure server enclave 40, itself included in the computer server 12. In this case, the request Req_{F} is transmitted to the encryption unit 50 by the transmission module 52 included in the client equipment 14. Preferably, the transmission of the request Req_{F} between the transmission module 52 and the secure server enclave 40 is performed via the secure channel 16.

The encrypted request [Req_{F}] is then transmitted to the management module 22.

In a second step 110, the management module 22 applies the homomorphic operation to the encrypted request [Req_{F}] in order to deliver the ciphertext [F] of the file F. The ciphertext [F] corresponds to the file F encrypted via the encryption algorithm and the encryption key.

The ciphertext [F] is then transmitted to the masking module 24.

In a third step 120, the masking module 24 randomly generates the mask M and adds the mask M to the encrypted file [F] in order to form the ciphertext [F+M] from the file F and the mask M combination.

In addition, the masking module 24 transmits the mask M to the secure client enclave 34 included in the client equipment 14. Preferably, the transmission of the mask M is performed via the secure channel 16. In other words, the transmission of the mask M is performed directly to the secure client enclave 34 via the secure channel 16, without the client equipment 14 then being able to access the mask M.

Alternatively, when the mask M is not transmitted via the secure channel to the secure client enclave 34, the mask M is advantageously transmitted in encrypted form to the secure client enclave 34, this encrypted transmission also being to prevent access to the mask M by the client equipment 14. Encrypted transmission of M does not necessarily require homomorphic encryption.

In a fourth step 130, the encrypted [F+M] combination of the file F and the mask M is decrypted using the decryption algorithm and decryption key.

According to the first and fourth embodiments, the masking module 24 transmits the encrypted [F+M] combination to the decryption module 32 included in the client equipment 14. The decryption module 32 then decrypts the encrypted [F+M] combination, then transmits the decrypted F+M combination of the file F and the mask M to the unmasking unit 36 of the secure client enclave 34.

According to the second and third embodiments, the masking module 24 transmits the encrypted combination [F+M] to the decryption unit 42 included in the secure server enclave 40. The decryption unit 42 then decrypts the encrypted [F+M] combination, then transmits the decrypted combination F+M combination of the file F and the mask M to the unmasking unit 36 of the secure client enclave 34. Preferably, the transmission is performed via the secure channel 16.

In a fifth step 140, the unmasking unit 36 removes the mask M from the F+M combination, in order to transmit the executable file F in clear to the implementation unit 38 included in the secure client enclave 34.

In a sixth and final step 150, the implementation unit 38 takes as input the data D_{C} from the client equipment 14, executes the file F on the data D_{C} and returns the result F(D_{C}) of the execution to the client equipment 14.

Thanks to the features described above, the computer server 12 then shares the file F with the client equipment 14, which executes it on the data D_{C} within the secure client enclave 34, and the client equipment 14 sends only the request Req for access to the F file to the computer server 12, and does so securely, in particular, so that the computer server 12 has no knowledge of the identity of the desired file F.

Contrary to the state of the art, where the client equipment 14 sends the encrypted data D_{C} to the computer server 12 and the computer server 12 executes the file F on the encrypted data D_{C}, then returns to the client equipment the encrypted result F(D_{C}), the execution then being particularly long; the computer server 12 according to the invention only processes the encrypted request [Req_{F}] in encrypted form, which greatly improves the performance of the computer server 12, while ensuring the confidentiality explained above, both for the computer server 12 and for the client equipment 14.

The exchange of data between the computer server 12 and the client equipment 14 can then be described as “double blind”, with the computer server 12 having no knowledge of the content of the request Req_{F} from the client equipment 14, and the client equipment 14 then having no knowledge of the content of the file F returned by the computer server 12 in response to this request.

1. A computer server comprising:
a database of computer files;
a management module configured to receive a request containing a first identifier of a client equipment and a second identifier of a file from among the files in the database, the second identifier included in the request having been encrypted via a homomorphic encryption algorithm and an encryption key; the management module then being configured to apply a homomorphic operation to the request to deliver a ciphertext of the file corresponding to the second identifier, the encrypted file being encrypted according to the homomorphic encryption algorithm and the encryption key;
a masking module connected to the output of the management module, the masking module being configured to receive the ciphertext of the file, to generate a mask and to deliver a ciphertext of a combination of the file and the mask;
the masking module being further configured to transmit the mask to a secure client enclave included in the client equipment corresponding to the first identifier, the secure client enclave then being able to receive the combination of the file and the mask, and then to remove the mask for implementation of the file within the secure client enclave.

2. The computer server according to claim 1, wherein the encrypted request is received from an encryption module included in the client equipment, the encryption module being configured to encrypt the second identifier included in the request via the homomorphic encryption algorithm and the encryption key.

3. The computer server according to claim 1, wherein the computer server further comprises a secure server enclave, the secure server enclave comprising an encryption unit, the encryption unit being configured to receive the request from a transmission module included in the client equipment, to encrypt the second identifier included in the request via the homomorphic encryption algorithm and the encryption key, and to supply to the management module the encrypted request.

4. The computer server according to claim 1, wherein the masking module is configured to transmit the encrypted combination of the file and the mask to a decryption module included in the client equipment, the decryption module being configured to decrypt the encrypted combination of the file and the mask using a decryption algorithm and a decryption key, and to transmit the decrypted combination of the file and the mask to the secure client enclave.

5. The computer server according to claim 1, wherein the computer server further comprises a secure server enclave, the secure server enclave comprising a decryption unit, the decryption unit being configured to decrypt the encrypted combination of the file and the mask via a decryption algorithm and a decryption key, and to transmit the decrypted combination of the file and the mask to the secure client enclave.

6. The computer server according to claim 1, wherein each secure enclave is chosen from among the group consisting of: an ARM® TrustZone® enclave and an Intel® Software Guard Extensions enclave.

7. The computer server according to claim 1, wherein the mask is generated randomly or pseudo-randomly and is for single use.

8. The computer server according to claim 7, wherein the mask is generated via a disposable mask method.

9. The computer server according to claim 7, wherein the mask is generated via a pseudo-random function.

10. The computer server according to claim 1, wherein the homomorphic encryption algorithm is an additive homomorphic encryption algorithm.

11. The computer server according to claim 1, wherein the second identifier of the encrypted request is a vector of ciphertexts, the size of the vector being equal to the number of computer files in the database.

12. The computer server according to claim 11, wherein the homomorphic operation applied to the encrypted request is a scalar product.

13. A client-server system comprising a client equipment and a computer server connected to each other, wherein the computer server is according to claim 1.

14. The client-server system according to claim 13, comprising at least one secure channel configured to transmit an information between the client equipment and the computer server.

15. A method for exchanging data between a computer server and the client equipment, the computer server comprising a database of computer files, the method comprising:
homomorphic encryption of a request using a homomorphic encryption algorithm and an encryption key, the request containing a first identifier of the client equipment and a second identifier of a file from among the files in the database, only the second identifier being encrypted;
application of a homomorphic operation to the encrypted request to deliver a ciphertext of the corresponding file to the second identifier;
generation of a mask and addition of the mask to the ciphertext of the file to form a ciphertext of a combination of the file and the mask;
decryption of the ciphertext of the combination of the file and the mask via a decryption algorithm and a decryption key;
removal of the mask from the decrypted combination of the file and the mask in a secure client enclave included in the client equipment corresponding to the first identifier;
implementation of the file in the secure client enclave.
